(19) United States
(12) Patent Application Publication
(10) Pub. No.: US 2008/0054043 A1
(43) Pub. Date: Mar. 6, 2008

(54) Nailer Device

(76) Inventor: Gavin Beales, Tyne & Wear (GB)

Correspondence Address: GABLE & GOTWALS, 100 WEST FIFTH STREET, 10TH FLOOR, TULSA, OK, 74103, US

(21) Appl. No.: 11/572,564

(22) PCT Filed: Jul. 22, 2005
(86) PCT No.: PCT/GB05/02889

§ 371 Date: Feb. 23, 2007

(30) Foreign Application Priority Data
Jul. 23, 2004 (GB) 0416473.7
Jun. 10, 2005 (GB) 0511800.5

(51) Int. Cl. B25C 1/06; B25C 1/18

(52) U.S. Cl. 227/129

(57) ABSTRACT

A portable reciprocal action power tool, which provides force to striking means (20) to move nails (26) or other components into a substrate in a reciprocating manner. A component (26) is held by jaws (22) provided on the power tool, which release the component (26) as the user pushes the tool against the substrate.

The invention to which this application relates is a portable reciprocal action nailer power tool, also known as a nail gun.

Although the following description refers almost exclusively to use of a power tool to drive nails into a substrate, it will be appreciated by persons skilled in the art that the present invention can be used to drive other components or securing means, such as rivets, bolts, fasteners and/or the like.

In order to fix a material to a substrate, nails are typically struck to pass through the material and into the substrate, thereby securing the same. It is possible for a user to strike a nail with repeated blows from a hammer, although this can be quite tiring and time-consuming.

In industry, nailer devices are often used. Conventional nailer devices are usually pneumatic single-strike action devices, whereby the nail is placed in the device and struck with one blow to force the nail into position. This arrangement allows the device to be fitted with a cartridge containing a plurality of nails, the user moving the device after each strike to insert nails successively. However, the force required to insert a nail in a single strike is often high, and pneumatic devices may require compressors for the air supply, or expensive gas cartridges. This means that conventional nailer devices are typically large and heavy, and require mains power for practical operation to achieve the aforementioned force. They are also not suitable for more fragile surfaces, which may break under the stress caused by the high force of the single strike action. In addition, as the device shoots nails with high force, it may be very dangerous in the hands of an inexperienced user.

Furthermore, conventional nailer devices typically do not have a power level setting, and the final position of the nail is determined by (a) the force generated by the nailer device; (b) the friction between the nail shank and substrate; and/or (c) the shape of the ends of the nail (a flattened nail head can help prevent the same from entering the substrate further than the head of nail). If the nailer device is underpowered, or the substrate is resilient, the nails will not fully enter the substrate, and the heads will protrude, often unevenly due to variations in the substrate. If the nailer device is overpowered, or the substrate is weak, the nails may be forced right through and/or beyond the substrate.

The aim of the present invention is to provide a nailer device which inserts nails into a substrate incrementally using a reciprocating action and thereby overcomes the above disadvantages.

In a first aspect of the invention, there is provided a power tool including motor means to provide force to a striking means, said striking means capable of applying a striking force to a component to move the component, and characterised in that said striking means is moved in a reciprocating manner.

Typically the striking means strikes the component multiple times such that it is forced to move incrementally.

Typically the component is forced into a substrate by the repeated force of the striking means.

In one embodiment the component has a head, such as a nail, which is struck by the striking means.

As a result of the reciprocating movement, the striking means, for each blow on the nail, need not provide a force which causes the nail to be fully inserted into the substrate by one blow. Instead the nail can be fully inserted following a number of repeated blows from the striking means.

In one embodiment, power means are provided in the form of one or more batteries, preferably in the form of a detachably attached battery pack. Preferably the batteries are rechargeable. The power tool is therefore not restricted by connections to further devices for providing power to the motor in accordance with this invention.

Alternatively, the power means may be any or any combination of mains electricity, gas canisters, fluid compressors, and/or the like.

In one embodiment the motor means comprises one or more electric motors which are driven when the power is supplied thereto, typically by user actuation of a switching means. In one embodiment the degree and/or duration of operation of the switching means by the user can be used to determine the striking force applied on each blow on the nail and/or frequency of the blows.

In an alternative embodiment the motor means is any or any combination of electric, pneumatic or hydraulic means.

Typically the motor means provides force to the striking means via reciprocating means and the reciprocating means can comprise one or more cogs, crank shafts, hammers, and/or pistons.

In one embodiment the power tool includes an elongate shaft, and the striking means, hammers and/or pistons are located therein.

Typically the hammer and/or piston moves along the inside of the elongate shaft in a reciprocating manner.

Preferably the striking means is in the form of an anvil. In one embodiment the anvil is provided with an angled face such that force can be applied to the component without the anvil striking the substrate when close thereto. Typically the anvil is provided with a concave face to bias the head of the nail or other component to the centre of the face.

Typically the piston movements compress and expand a fluid between the piston, hammer, and/or anvil to move the same along the elongate shaft in a reciprocal manner such that the piston or hammer engages the anvil with a striking force. Typically the fluid is air, and the air gap between opposing faces of the piston, hammer, and/or anvil prevents mechanical damage to the power tool caused by engagement of the piston, hammer, and/or anvil.

In one embodiment the piston is an open ended tubular portion and at least part of the hammer is situated inside the tubular portion. The hammer may frictionally engage the inner wall of the tubular portion, or may be provided with engagement means such as springs or rubber seals, to dampen the movement of the hammer as the piston moves back and forth. The dampened movement allows the hammer to engage the anvil in a smoother action and reduces stress on the device. An opening may also be provided in the piston or the hammer to allow air to flow into the air gap between the piston and hammer, which would also dampen the movement, as pressure would be released via the opening.

In an alternative embodiment the piston is a solid cylinder. In this embodiment the hammer moves freely along the elongate shaft in response to movement of the piston.

Typically the anvil is provided with a protrusion or pin to allow the anvil to be retained inside the elongate shaft.

In one embodiment the power tool is provided with clamping means at the anterior of the elongate shaft.

Typically the clamping means include any or any combination of jaws, springs, magnets, screws, chucks, and/or the like for gripping a component in position. Typically the clamping means are aligned with the elongate shaft and substrate and are capable of tightening and/or loosening the grip on a component gripped thereby.

Typically the clamping means can be adjusted to receive any or any combination of nails, rivets, bolts, fasteners, and/or the like.

In a further embodiment the power tool is provided with a head assembly, slidably mounted on the outside of the elongate shaft.

In this embodiment the head assembly is provided with a body portion, and clamping means form part of the head assembly for gripping a component at the anterior of the elongate shaft.

Preferably the clamping means are moveable between an open position and a closed position. Typically the clamping means are axially retractable to allow insertion and/or removal of a component therebetween.

Typically the elongate shaft does not extend between the clamping means. Alternatively the elongate shaft is capable of extending between the clamping means.

Typically the head assembly is provided with one or more distance members.

In one embodiment first biasing means are provided to bias the body portion towards the distal end of the elongate shaft.

Typically second biasing means are provided to bias the clamping means towards the distal end of the elongate shaft.

Typically third biasing means are provided on the body portion to bias the clamping means to an open position, and are less powerful than the first and/or second biasing means.

Typically the first and/or second biasing means biases the clamping means to a closed position.

In one embodiment actuating means are provided for moving the clamping means away from the distal end of the elongate shaft.

Typically the distance members are fixedly mounted in the head assembly adjacent the clamping means, and the distance members and/or the clamping means are provided with angled edges such that as the clamping means are moved away from the distal end of the elongate shaft, the third biasing means biases the clamping means to an open position.

Thus the actuating means is actuated to move the clamping means within the head assembly, thereby opening the clamping means and allowing a component to be positioned therebetween or removed.

Typically, a user applies force to overcome the third biasing means to allow the component to be moved into the substrate by the striking means. Typically, as the component is moved into the wall and the clamping means are opened to release the component from the clamping means, the user applies force to overcome the first and/or second biasing means to move the component further into the substrate.

Preferably the clamping means are laterally adjustable such that the component can be inserted into the substrate to a specific depth of component and/or substrate.

Typically the clamping means include overlapping V-shaped portions for gripping the shank of a nail therebetween. The V-shaped portions thus act as nail guides. Alternatively the clamping means can be shaped to provide a grip on other components.

In one embodiment a component holder is provided on the power tool for holding a plurality of components. Typically the component holder is magnetic, and in one embodiment is capable of aligning the components when placed thereon.

In one embodiment a cartridge containing a plurality of components may be connected to the power tool. Typically the cartridge allows components to be inserted into the substrate successively without the need for a user to manually insert components into the clamping means on each occasion.

In one embodiment the power tool is provided with switching means in the form of a trigger. Preferably the user actuates the switching means to selectively provide power to the motor means.

In a further aspect of the invention there is provided a power tool including motor means to provide force to a striking means, said striking means capable of applying a striking force to a component to move the component, and characterised in that said striking means is moved to provide successive blows to the component to move the same into the substrate.

In a further aspect of the invention there is provided a clamping means for use in locating at least one nail with respect to a power tool, said clamping means provided for location at an elongate shaft of the power tool from which a striking force is received by the nail head when held in position, said clamping means including one or more jaws for gripping the nail in position and one or more distance members, characterised in that said one or more jaws release the nail when the one or more distance members are pushed against a substrate.

In one embodiment the clamping means are selectively movable with respect to the nailer device so as to position the nail head with respect to the device such as to control the level of force applied to the nail head upon contact with the striking means of the nailer device.

In one embodiment the clamping means can be retrofitted to a reciprocal-action tool to convert the tool into one which can move nails or other components into a substrate in a reciprocal fashion as herein described.

Specific embodiments of the invention are now described wherein:—

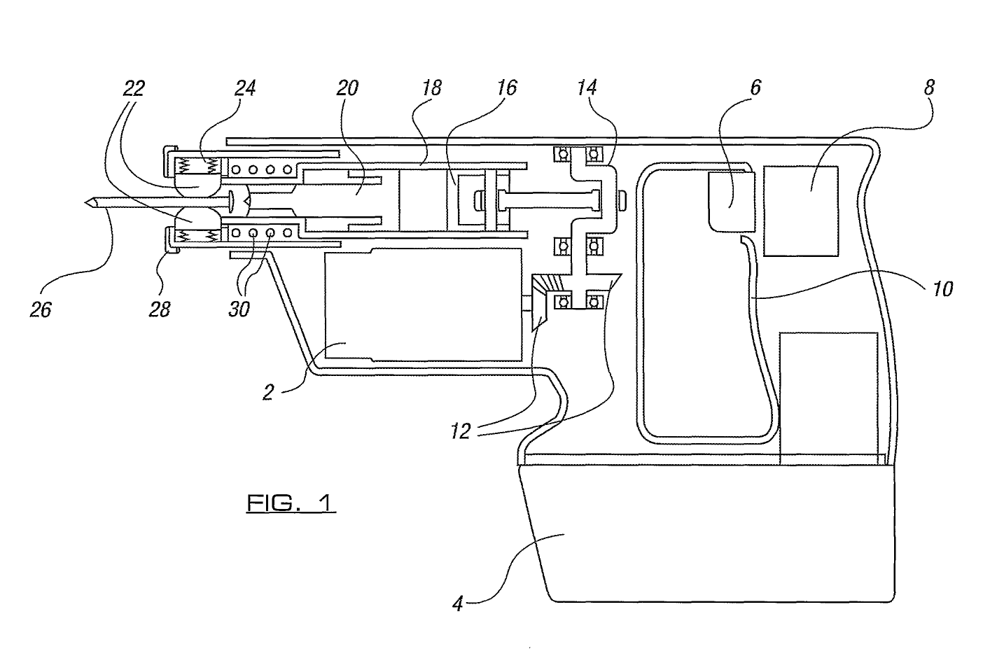

FIG. 1 illustrates a schematic view of a power tool according to one embodiment of the invention.

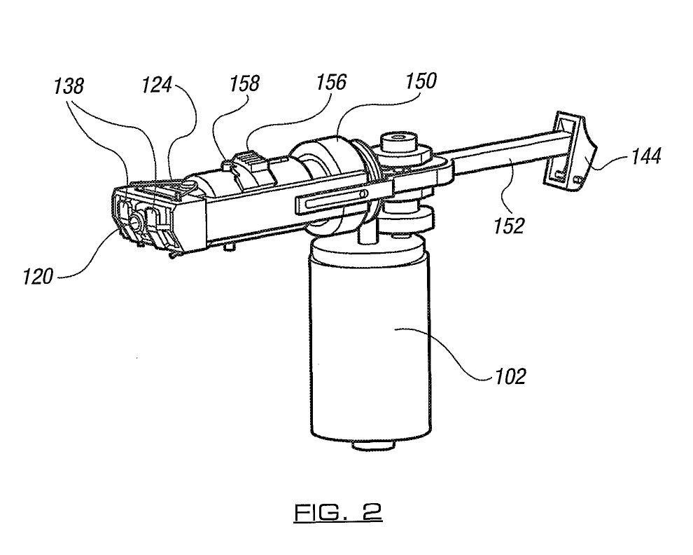

FIG. 2 illustrates a perspective view of a power tool in accordance with a second embodiment of the invention.

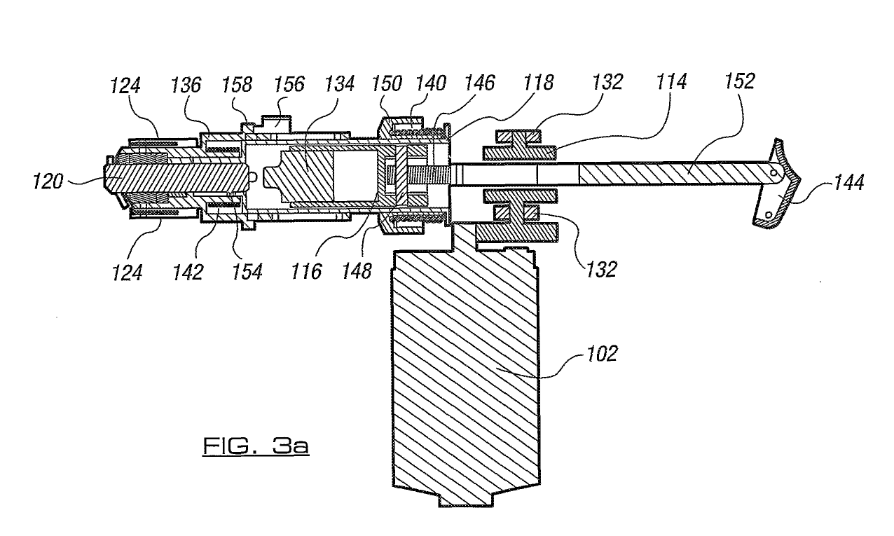

FIG. 3 illustrates cross sectional views of the second embodiment of the invention (a) from the side (b) from above.

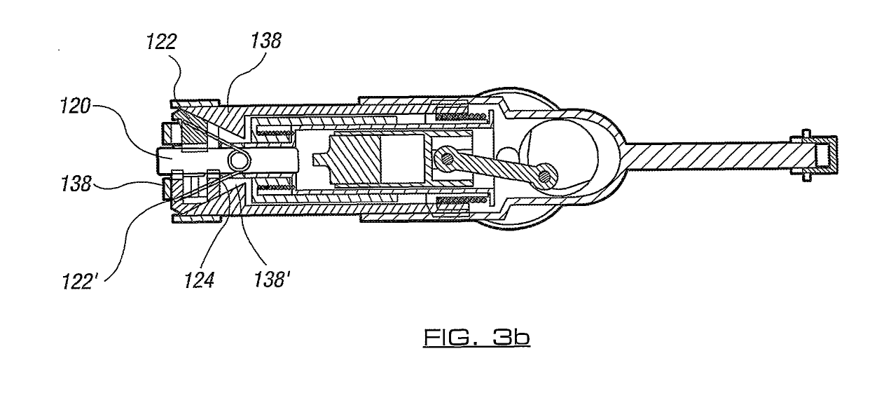

FIG. 4 illustrates a perspective view of the jaws of the second embodiment of the invention holding a nail (a) from the front of the jaws (b) from the rear of the jaws.

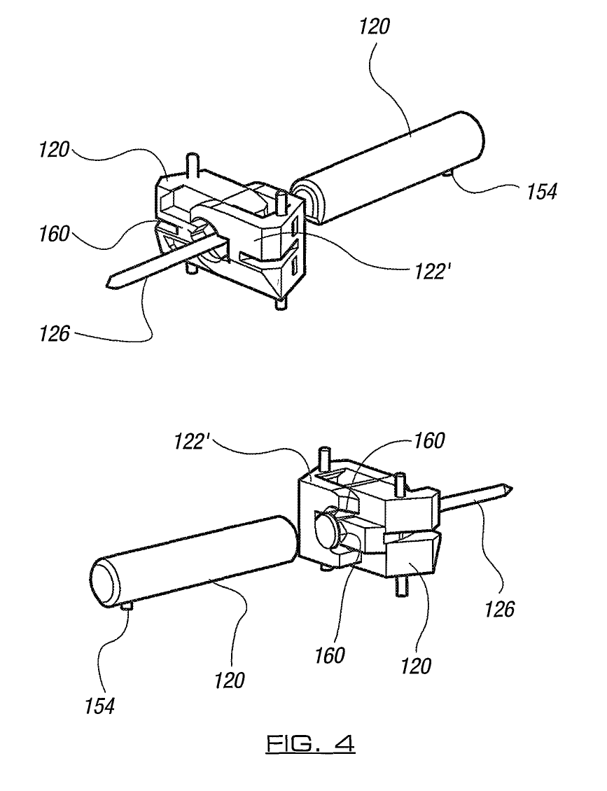

FIG. 5 illustrates the jaws of the second embodiment of the invention in more detail.

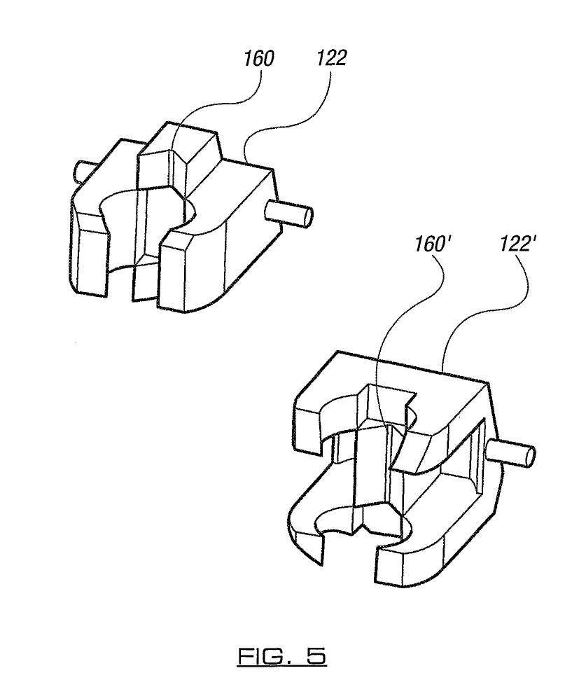

FIG. 6 illustrates a variation in the clamping means of the second embodiment of the invention.

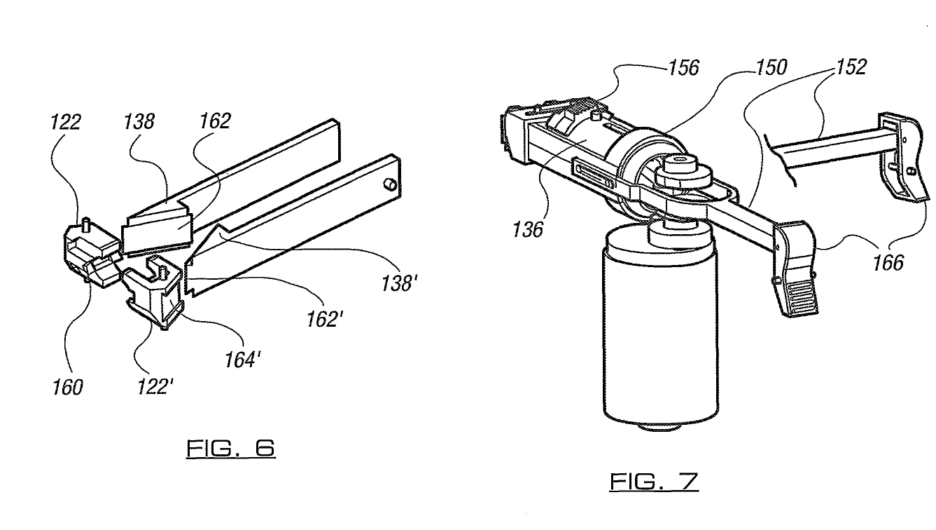

FIG. 7 illustrates an alternative actuating means of the second embodiment of the invention.

With reference to FIG. 1, there is illustrated a power tool in the form of a nailer device including an electric motor 2 powered by a rechargeable battery pack 4, the power connection to the motor being selectively controlled by a user operating actuating means in the form of a trigger 6 connected to a switch 8. The motor 2 and battery 4 are preferably relatively small, lightweight, and low-powered, akin to those found in cordless drills and the like. As such, the nailer device is highly portable and can be supported in one hand by a user via the hand grip 10. The motor 2 rotates cogs 12, which are connected to and rotate crank shaft 14. The crank shaft 14 moves piston 16 backwards and forwards along elongate shaft 18 in a reciprocating manner. The shaft 18 also contains an anvil 20. As the air in the shaft 18 between the anvil 20 and piston 16 is compressed and expanded by the movement of the piston 16, the anvil 20 is moved backwards and forwards along elongate shaft 18 in a reciprocating manner by the same. In a forwards movement the anvil 20 acts to strike a component, in this example a nail 26, the head of which is placed in the anterior end of the shaft 18, with the head being struck upon each forward stroke of the piston and hence movement of the anvil such that the nail 26 is inserted incrementally into a substrate until the same is fully inserted. The speed of this action can be controlled, such as by an external dial (not shown) which can be set to various speed levels, or by the amount by which the trigger is depressed to proportionally vary the amount of power supplied to the motor. Typically the maximum speed of the action is in the region of 4500 bpm. As the nail 26 is driven into the substrate by delivering a number of relatively low-energy impacts, the system does not require a dangerously high level of releasable energy to be stored to achieve the insertion of the nail

The nailer device includes clamping means in the form of nail clamps 22 which are provided with springs 24 such that the clamps 22 grip the nail 26 placed therebetween. The nail clamps may be provided with a retractable collar 28 to help hold the nail in position as the same is inserted into the substrate. The nail clamps 22 and/or collar 28 may be adjustably secured to the nailer device at securing points 30 such that nails are inserted to a user-specified depth. The nails can be allowed to protrude, be flush, or even be recessed into the surface in this way.

The nail clamps 22 and/or collar 28 can also be removed from the nailer device and retrofitted to an alternative reciprocal action device, such as a hammer drill, such that the same can be adapted to the purpose hereinbefore described.

In use, a user places a nail 26 between the nail clamps 22 such that the head protrudes into the shaft 18. The nailer device is then positioned such that the nail 26 is adjacent the substrate. The user then actuates the trigger 6 to engage the motor 2 and the reciprocating anvil 20. As the user pushes the nailer device towards the substrate, the head of the nail 26 is struck repeatedly by the anvil 20, incrementally inserting the nail 26 into the substrate as hereinbefore described. The speed of the striking action can be increased by increasing the pressure on the trigger 6. A cartridge of nails may also be fitted to the nailer device so that successive nails are automatically placed between the nail clamps 22 as a user releases the previously inserted nail 26.

With reference to FIGS. 2-3, there is illustrated a second embodiment of the nailer device power tool including an electric motor 102 which rotates crank shaft 114 via bearing 132. The crank shaft 114 is connected to piston 116 via connecting rod 146 and piston pin 148, and moves piston 116 backwards and forwards along elongate shaft 118 in a reciprocating manner. The piston pin 148 and connecting rod 146 are threadedly engaged to allow adjustment of the relative position of the same. The shaft 118 also contains a hammer 134 and an anvil 120. The piston 116 is provided with an open ended tubular structure, concentric with the elongate shaft 118, in which at least part of the hammer 134 is situated. As the air in the shaft 118 between the opposing faces of the hammer 134 and piston 116 is compressed and expanded by the movement of the piston 116, the hammer 134 is moved backwards and forwards within the tubular structure and along the elongate shaft 118 in a reciprocating manner by the same. The hammer 134 fits tightly inside the piston 116, while still allowing the reciprocal movement, such that movement of the hammer 134 is dampened as the piston 116 moves back and forth. Effectively the inertia of the hammer 134 is increased. In this embodiment the part of the hammer 134 is retained within the tubular structure. The dampened movement allows the hammer to engage the anvil 120 in a smoother action and reduces stress on the device.

In a forwards movement the hammer 134 strikes the anvil 120, which in turn acts to strike a component such as a nail 126, the head of which is placed in the anterior end of the shaft 118, with the head being struck multiple times by the anvil 120 upon each forward stroke of the piston 116 such that the nail 126 is inserted incrementally into a substrate until the same is fully inserted. The anvil is provided with a pin 154 to prevent it from being accidentally removed from the elongate shaft 118.

The nail 126 or other component is held in the shaft by a head assembly comprising a body portion 136 and clamping means in the form of jaws 122, 122′ mounted therein, the assembly being slidably mounted on the elongate shaft 118. The anvil 120 passes through the end of the elongate shaft 118 in the body portion, and can extend through the jaws 122, 122′. The elongate shaft 118 in this example does not extend into the head assembly to be gripped by the jaws 122, 122′, such that the jaws 122, 122′ do not have to move apart so far to allow the anvil 120 to pass therethrough as if the elongate shaft 118 also passed therethrough. The body portion 136 includes angled edges 138, 138′ which engage the adjacent angled edges of jaws 122, 122′ such that as the jaws move away from the distal end of the elongate shaft 118, they are moved closer together by the angled edges 138, 138′. As the jaws 122, 122′ are adjustable, a range of different sized nails or other components can be held individually by the same.

First biasing means are provided in the form of a spring 140 to bias the body portion 136 towards the component locating distal end of the elongate shaft 118. Second biasing means are provided in the form of a spring 142 to bias the jaws 122, 122′ towards the distal end of the elongate shaft 118, thereby biasing the jaws 122, 122′ to a closed position. Third biasing means are provided in the form of springs 124 on the body portion 136 to bias the jaws 122, 122′ to an open position, and are less powerful than the first and second biasing means 140, 142 such that an external force must be provided by a user to open the jaws 122, 122′.

This external force can be provided via actuating means in the form of a trigger 144, which is connected via a frame member 152 to a sleeve 150 housing the spring 140 and the body portion 136. As the trigger 144 is actuated, the body is moved away from the distal end of the elongate shaft 118, allowing the jaws 122, 122′ to be biased towards the open position, and with further actuation the rest of the head assembly is moved away from the distal end of the elongate shaft 118, allowing the anvil 120 to move further along the elongate shaft 118, through the jaws 122, 122′, to strike the nail 126 further into the substrate.

An adjustable switch 156 with notches is provided so that the jaws 122, 122′ can be set to different nail shank depths by rotating the switch 156 around the elongate shaft 118 so that the protrusion 158 fits into different notches. Thus the nailer device can be adjusted to move nails 126 into a substrate to a specified depth.

Distance members 138 are mounted in the head assembly adjacent the jaws 122, 122′ and are connected to the jaws having angled edges such that as the jaws 122, 122′ are moved away from the distal end of the elongate shaft 118, as the distance members 138 engage the substrate, the springs 124 bias the jaws 122, 122′ to an open position. This allows the nail 126 to be partially moved into the substrate before being released to allow the nail 126 to be moved all the way into the substrate by action of the anvil 120 moving out of the elongate shaft 118 between the jaws 122, 122′.

With reference to FIGS. 4-5, the jaws 122, 122′ of the second embodiment of the invention are shown in more detail. It can be seen that the jaws 122, 122′ interlock, gripping the nail 126 between adjacent V-shaped portions 160, 160′ to ensure a tight hold on the shank. As the head of the nail cannot pass through in this position, as the nail is moved into the substrate and thus held by the substrate, the jaws open to allow the head to pass therethrough for release of the nail, and/or the anvil 120 to pass therethrough to continue striking the nail 126 close to the substrate to move the nail completely into the substrate.

In use, a user actuates the trigger 144 to open the jaws 122, 122′ and places a nail 126 between the jaws such that the head of the nail protrudes into the shaft 18. The nailer device is positioned such the nail 126 is adjacent the substrate. The user then engages the motor 102 and the reciprocating anvil 120. As the user pushes the nailer device towards the substrate, the head of the nail 126 is struck repeatedly by the anvil 120, incrementally inserting the nail 126 into the substrate as hereinbefore described. The nail 126 is thus safely gripped by the jaws 122, 122′ until the nail 126 is at least partly embedded into the substrate, and the user exerts additional force against the substrate. Thus, in contrast to conventional nail guns, there is no danger of the nail being ‘shot’ from the device if the user points the device away from the substrate.

With reference to FIG. 6 there is illustrated a variant of the clamping means, wherein the angled edges 138, 138′ of the body portion 136 are provided with protrusions 162, 162′ which engage the adjacent angled edges of jaws 122, 122′ via recessed guides 164′. In this example the protrusions and guides slot together in a dovetail fashion, allowing the jaws to slide along the guides. As the jaws 122, 122′ are slidably mounted on the guides 164, there is no requirement for springs 124 as indicated by FIGS. 2-3 to bias the jaws 122, 122′ to an open position, thereby simplifying the mechanism.

Referring to FIG. 7 there is shown a variant in the actuating means as a trigger 166, which is pushed in a see-saw fashion, rather than pulled, to move the body 136 away from the distal end of the elongate shaft 118, opening the jaws 122, 122′ and moving the rest of the head assembly from the distal end of the elongate shaft 118 as hereinbefore described.

It will be appreciated by persons skilled in the art that the present invention also includes further additional modifications made to the device which does not effect the overall functioning of the device.

1. A power tool including motor means to provide force to a striking means, said striking means capable of applying a striking force to a component to move the component, and said striking means is moved in a reciprocating manner via reciprocating means, characterised in that there is provided clamping means moveable between an open position for receiving the component and a closed interlocked position for gripping the component.

2. A power tool according to claim 1 characterised in that the clamping means include overlapping V-shaped portions suitable for gripping the shank of a nail therebetween.

3. A power tool according to claim 1 characterised in that the striking means strikes the component multiple times such that the component is moved incrementally into a substrate.

4. A power tool according to claim 3 characterised in that the striking means is provided with an angled face such that force can be applied to the component without the striking means striking the substrate when close thereto.

5. A power tool according to claim 1 characterised in that the striking means is provided with a concave face to bias the component to the centre of said face.

6. A power tool according to claim 1 characterised in that the power means are provided which are detachably attached and/or rechargeable.

7. A power tool according to claim 6 characterised in that the power means is any or any combination of batteries, mains electricity, gas canisters, or fluid compressors.

8. A power tool according to claim 1 characterised in that the motor means comprises any or any combination of electric, pneumatic or hydraulic motors, which are driven when power is supplied thereto

9. A power tool according to claim 1 characterised in that the switching means are provided to allow the supply of power to the motor means, and the degree and/or duration of operation of the switching means by the user can be used to determine the striking force applied to the component and/or frequency of the strikes thereto.

10. A power tool according to claim 1 charactetised in that said reciprocating means and/or striking means are at least partly located within an elongate shaft.

11. A power tool according to claim 10 characterised in that movement of at least part of the reciprocating means compresses and expands air and/or other fluid to move other parts of the reciprocating means and/or striking means along the elongate shaft in a reciprocal manner such that force is provided to the striking means.

12. A power tool according to claim 1 characterised in that the reciprocating means comprises a piston in the form of an open ended tubular portion, and a hammer, and at least part of the hammer is situated inside the tubular portion.

13. A power tool according to claim 12 characterised in that the hammer frictionally engages the inner wall of the tubular portion, or is provided with engagement means in the form of springs or rubber seals, to dampen the reciprocal movement of the hammer

14. A power tool according to claim 12 characterised in that an opening is provided in the piston and/or hammer to allow air and/or other fluid to flow into the gap between the piston and hammer.

15. A power tool according to claim 10 characterised in that the reciprocating means comprises a piston in the form of a solid cylinder, and a hammer, said hammer moving freely along the elongate shaft in response to movement of the piston.

16. A power tool according to claim 10 characterised in that the striking means is provided with a protrusion or pin to allow the striking means to be retained inside the elongate shaft.

17. A power tool according to claim 10 characterised in that the clamping means includes any or any combination of jaws, springs, magnets, screws, or chucks, which are provided at the anterior of the elongate shaft.

18. A power tool according to claim 10 characterised in that the clamping means are aligned with the elongate shaft and are capable of being adjusted to receive and/or grip components including any or any combination of nails, rivets, bolts, or fasteners.

19. A power tool according to claim 10 characterised in that the clamping means are formed as part of a head assembly, said head assembly further including a body portion, said head assembly slidably mounted on the outside of the elongate shaft.

20. A power tool according to claim 1 characterised in that said clamping means are axially retractable to allow insertion and/or removal of a component therebetween.

21. A power tool according to claim 10 characterised in that said elongate shaft does not extend through said clamping means.

22. A power tool according to claim 10 characterised in that said elongate shaft extends through said clamping means.

23. A power tool according to claim 19 characterised in that biasing means are provided to bias the body portion towards the distal end of the elongate shaft and/or bias the clamping means towards the distal end of the elongate shaft and/or bias the clamping means to a closed position.

24. A power tool according to claim 23 characterised in that biasing means are provided to bias the clamping means to an open position which are weaker than the biasing means provided to bias the clamping means to a closed position.

25. A power tool according to claim 23 characterised in that a user provides force to overcome the biasing means and move the clamping means to an open position, thereby releasing any component gripped by the clamping means to allow the same to be moved into a substrate.

26. A power tool according to claim 10 characterised in that distance members are provided adjacent the clamping means, and said distance members and/or clamping means are provided with angled edges such that as the clamping means are moved away from the distal end of the elongate shaft, the clamping means are moved to an open position.

27. A power tool according to claim 10 characterised in that actuating means are provided for moving the clamping means away from the distal end of the elongate shaft, thereby moving the clamping means to an open position.

28. A power tool according to claim 1 characterised in that the clamping means are laterally adjustable such that the component can be insetted into a substrate to a specific depth of component and/or substrate.

29. A power tool according to claim 1 characterised in that a component holder is provided for holding a plurality of components.

30. A power tool according to claim 29 characterised in that the component holder is magnetic and/or is capable of aligning the components when placed thereon.

31. A power tool according to claim 29 characterised in that the component holder is in the form of a cartridge containing a plurality of components which allows components to be inserted into a substrate successively without the need for a user to manually insert components into the clamping means on each occasion.

32. A power tool including motor means to provide force to a striking means, said striking means capable of being at least partly located within an elongate shaft and moving in a reciprocating manner to apply a striking force to a component to move the component, and clamping means moveable between an open position and a closed position, characterised in that actuating means are provided for moving the clamping means away from the distal end of the elongate shaft, thereby moving the clamping means to an open position.

33. A power tool according to claim 32 characterised in that biasing means are provided bias the clamping means towards the distal end of the elongate shaft and/or bias the clamping means to a closed position.

34. A power tool including motor means to provide force to a striking means, said striking means at least partly located within an elongate shaft and capable of moving in a reciprocating manner to apply a striking force to a component to move the component into a surface, and clamping means moveable between an open position and a closed position, characterised in that the elongate shaft and the striking means are capable of extending through the clamping means when open to allow the striking means to be guided and to strike the component at the surface, thereby moving the component substantially completely into the surface.

35. A clamping means for use in locating at least one nail with respect to a power tool, said clamping means provided for location at an elongate shaft of the power tool from which a striking force is received by the nail head when held in position, said clamping means including one or more jaws for gripping the nail in position and one or more distance members, the jaws releasing the nail when the one or more distance members are pushed against a substrate characterised in that the jaws are capable of interlocking.

36. A clamping means according to claim 35 characterised in that the clamping means are selectively movable with respect to the power tool so as to position the nail head with respect to the device such as to control the frequency of contact and/or level of force applied to the nail head upon contact with the striking means of the power tool.

37. A clamping means according to claim 35 characterised in that the power tool is a reciprocal-action tool, and the clamping means can be retrofitted to the tool to convert the tool into one which can move nails or other components into a substrate in a reciprocal fashion.

38. A power tool including motor means to provide force to a striking means, said striking means capable of applying a striking force to a component to move the component, said striking means is moved via reciprocating means to provide successive blows to the component to move the same into a substrate, said reciprocating means including a piston and a hammer for providing force to the striking means, characterised in that the piston includes a tubular portion in which at least part of the hammer is situated.

39. A power tool according to claim 38 characterised in that air and/or other fluid in the tubular portion is compressed and expanded by the movement of the piston which moves the hammer in a reciprocating manner.

40. A power tool according to claim 38 characterised in that engagement means are provided to dampen the reciprocal movement of the hammer.
